(19) United States
(12) Patent Application Publication
(10) Pub. No.: US 2016/0226204 A1
(43) Pub. Date: Aug. 4, 2016

(54) ELECTRICAL CONNECTOR

(71) Applicant: Ken Chen, New Taipei City (TW)

(72) Inventor: Ken Chen, New Taipei City (TW)

(21) Appl. No.: 14/609,852

(22) Filed: Jan. 30, 2015

(51) Int. Cl. H01R 24/60

(52) U.S. Cl. CPC H01R 24/60; H01R 2107/00

(57) ABSTRACT

The present invention relates to an electrical connector, including at least an insertion slot for other connectors to be correspondingly inserted thereinto, a plurality of conducting terminals respectively secured on two sides in the insertion slot with positive and negative terminals opposing each other, and a metal casing covering a circumference of the insulating body. A front edge at one end of the metal casing is arranged to backbend inwards to form an engagement part. The engagement part covers a rim opening at a front edge of the insulating body and is secured in a recession disposed at an inner side of the insertion slot from the rim opening inwards. In this manner, the rim opening of the insertion slot at a most front end of the electrical connector may be covered and protected, and is improved in its performance to bear repeated plugging and unplugging and to endure oppression. Additionally, a circumference of the insertion slot may be closely connected to the metal casing and keep the plurality of conducting terminals on two sides of the insertion slot stable to ensure stable signal transmission.

### CROSS-REFERENCE TO RELATED APPLICATIONS

The application claims priority from Taiwan Patent Application No. 103218337 filed on Oct. 16, 2014, the disclosure of which is incorporated herein by reference.

### BACKGROUND OF THE INVENTION

1. Field of the Invention

The present invention relates to a Universal Serial Bus (USB) connector, and particularly to a USB type-C electrical connector.

2. Description of Related Art

The USB connector is currently one of the commonly used types of connectors. An existing USB connector includes a plastic insulating body with an insertion slot arranged thereon. Inside the insertion slot are arranged several conducting terminals which are disposed on the surface of the insulating body evenly or zigzag aligned, or with variable intervals. A metal casing covers the insulating body to strengthen the structure of the connector, so that the connector will not easily deform under external force. However, such a metal casing may only cover around a circumference of the insertion slot on the insulating body. Besides, the trend of minimizing the size of connectors and maximizing their overall functions further demand downsizing of their components. Consequently, components of connectors are fragile and thin. Particularly, in the case of a compact USB type-C connector, when a male connector and a female socket connect to each other, a rim opening of the insertion slot on the insulating body which receives force is entirely unprotected. If force is inappropriately exerted or the angle of the opposing connection is deflected, the connector may easily crack or be damaged at the rim opening of the connector. As a USB connector is a transmission interface between electronic devices, it has to endure tens of thousands of plugging, unplugging, and oppression during its service life. Without a stable structure and proper protection, a connector will have reduced overall durability. After repeated plugging and unplugging, the insulating body and the casing may start to loosen, fall off, and be damaged. If conducting terminals for transmitting signals are arranged on a circumference of the insulating body, the stability of signal transmission will be seriously affected. As circuit layouts of connectors get more and more complicated and their functions gradually improve, increasing demand in stability and convenience cannot be ignored. With appropriate and practical components, the present invention may achieve an advantage of keeping signal transmission stable.

### SUMMARY OF THE INVENTION

In view of the foregoing considerations, a primary purpose of the present invention is to provide a connector for application to various electronic devices that may be installed on a circuit board to perform high-speed signal transmission with such advantages as stable signal transmission and durability.

To achieve the foregoing purpose, the electrical connector of the present invention includes at least an insulating body with an insertion slot for other connectors to be correspondingly inserted thereinto. On two sides in the insertion slot are respectively arranged a set of a plurality of conducting terminals of a same specification, with positive and negative terminals opposing each other. The insulating body is covered with a metal casing with a front edge at its one end backbending inwards to form an engagement part for covering a rim opening of the insertion slot and for fixedly engaging a recession formed on an inner side of the insertion slot from the rim opening inwards.

Compared to the prior art, the present invention provides a metal casing covering around a circumference of the insulating body which extends in a direction of a rim opening at a front edge of an insertion slot and backbends inwards into the insertion slot. The metal casing covers a rim opening at a front edge of the insertion slot and strengthens the durability and crashproofness of a connector. In addition, a circumference of the insertion slot is arranged to nestle closely to the metal casing. Support of the metal casing keeps a plurality of conducting terminals disposed on two sides of the insertion slot stable and ensures stable signal transmission. Preferred embodiments according to the present invention are described below in conjunction with the accompanying figures. The accompanying figures are only for reference and description without limiting the scope of the present invention.

### BRIEF DESCRIPTION OF THE DRAWINGS

FIG. 1 is a three-dimensional exploded view of a first preferred embodiment according to the present invention;

FIG. 2 is an assembly schematic view of a first preferred embodiment according to the present invention;

FIG. 3 is a cut-away schematic view of a first preferred embodiment according to the present invention;

FIG. 4 is a three-dimensional exploded view of a second preferred embodiment according to the present invention;

FIG. 5 is an assembly schematic view of a second preferred embodiment according to the present invention.

### DETAILED DESCRIPTION OF THE PREFERRED EMBODIMENTS

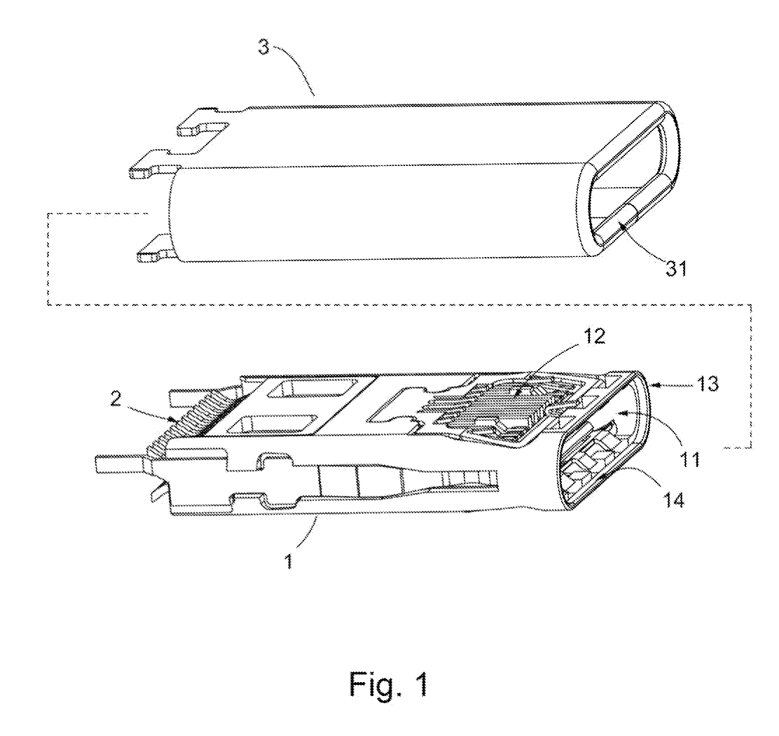

Please refer to FIG. 1. A three-dimensional exploded view of a first preferred embodiment according to the present invention is shown. Refer to other figures too. As the figures show, the present invention includes primarily an insulating body 1, a plurality of conducting terminals 2, and a metal casing 3. An end of the insulating body 1 has an insertion slot 11 in the shape of a mouth for other connectors to be correspondingly inserted thereinto. On two side walls in the insertion slot 11 is a terminal slot 12 for accommodating a plurality of conducting terminals 2. The terminal slot 12 communicates with the insertion slot 11. A recession 14 lower than the inner side surface of the insertion slot 11 is arranged inside the insertion slot 11 from a rim opening 13 inwards. The recession 14 of the present embodiment is arranged to indent in a completely annular shape along the rim opening 13 on a circumference of the insertion slot 11. The plurality of conducting terminal 2 is made of metal pressed and tailored into shape. Each of the conducting terminals is formed in the shape of a straight bar for being arranged to form two juxtaposing rows of sets of conducting terminals. The plurality of conducting terminals 2 conform to a specification of terminals of a standard USB Type-C female electrical connector. The metal casing 3 is a hollow annular structure made of metal that may cover a circumference of the insulating body 1. At a front edge at an end of the metal casing 3 is disposed an engagement part 31 that backbends inwards in a direction of the hollow annular shape. The engagement part of the present embodiment is arranged to backbend inwards in a completely annularly shape to correspondingly engage the recession 14 arranged to indent in a completely annular shape along the rim opening 13 on an inner side of the insertion slot 11.

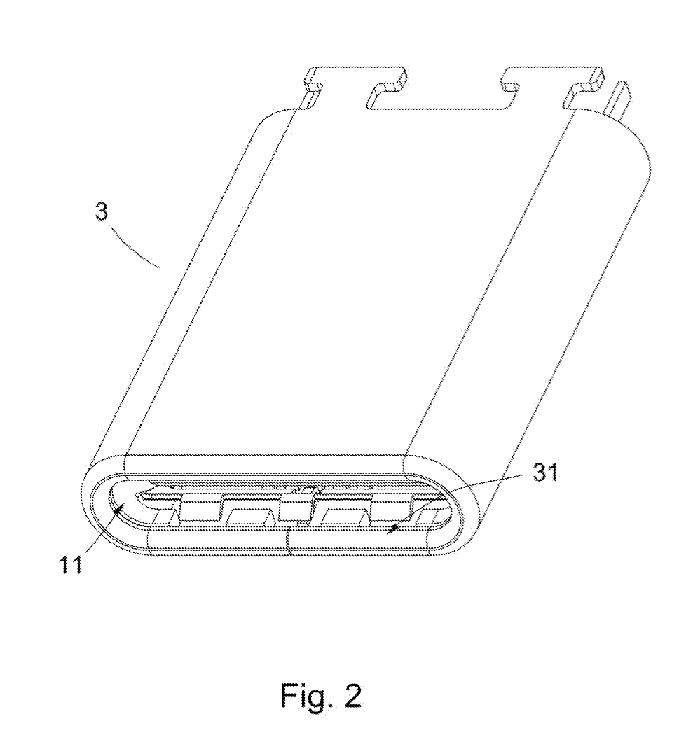

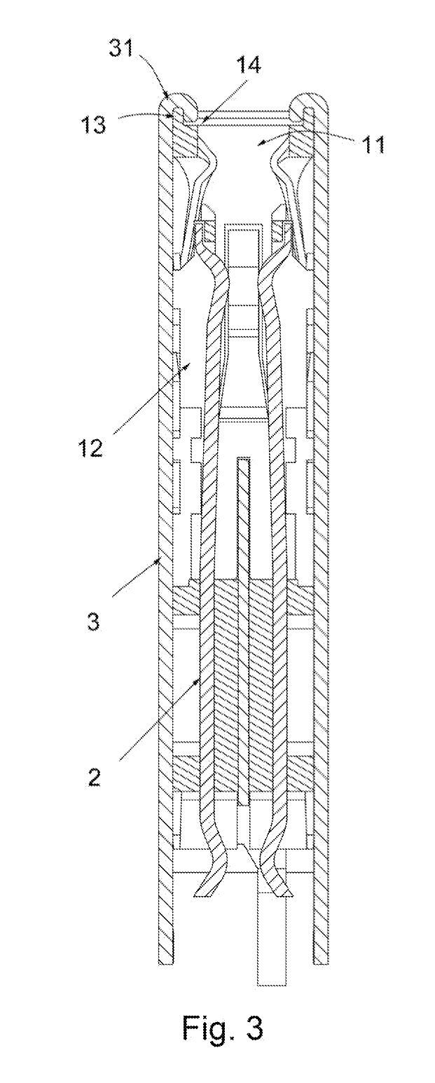

During assembly, the plurality of conducting terminals 2 are respectively secured in the terminal slot 12 on two sides of the insertion slot 11 on the insulating body 1, with positive and negative terminals opposing each other. The metal casing 3 accommodates and covers the insulating body 1 in its hollow annular shape. The engagement part 31 of the metal casing 3 that backbends inwards in a direction of the hollow annular shape precisely and correspondingly covers the rim opening 13 at a front edge of the insertion slot 11 (as FIG. 2 shows) and fixedly engage the recession 14 that is arranged to indent inwards from the rim opening 13 on an inner side of the insertion slot 11 on the insulating body 1. The depth in which the recession 14 indents in a direction of the insulating body 11 is equivalent to the thickness of the engagement part 31. The surface of the engagement part 31 that backbends and is secured to the recession 14 of the insertion slot 11 is approximately parallel and of a same height as the surface of an inner side of the insertion slot 11 (as FIG. 3 shows).

In the present invention, the metal casing 3 covering a circumference of the insulating body 1 is arranged to wrap around the rim opening 13 on the insulating body 1 and backbend inwards into the insertion slot 11. In this manner, the metal casing 3 covers the rim opening 13 on a front edge of the insulating body 1. Because the rim opening 13 at the most front edge of the insulating body 1 is protected via the covering of the metal casing 3 made of metal, the insulating body is desirably rigid and bears repeated plugging and unplugging. When connecting with other male connectors, even if a user oppresses an electrical connector of the present invention with inappropriately exerted force or the opposing connection is performed at a deflected angle, the electrical connector of the present invention will not easily crack or be damaged. Additionally, because the metal casing 3 does not only cover annularly a circumference of the insulating body 1 but also covers a front end of the insulating body 1 with an engagement part 31 that is arranged to backbend at a front edge of the metal casing 3, the plurality of conducting terminals 2 located on two sides of the insertion slot 11 may be more solidly positioned on the insulating body 1 and will not easily loosen or come off. Contact among the plurality of conducting terminals 2 is thus ensured to keep signal transmission stable.

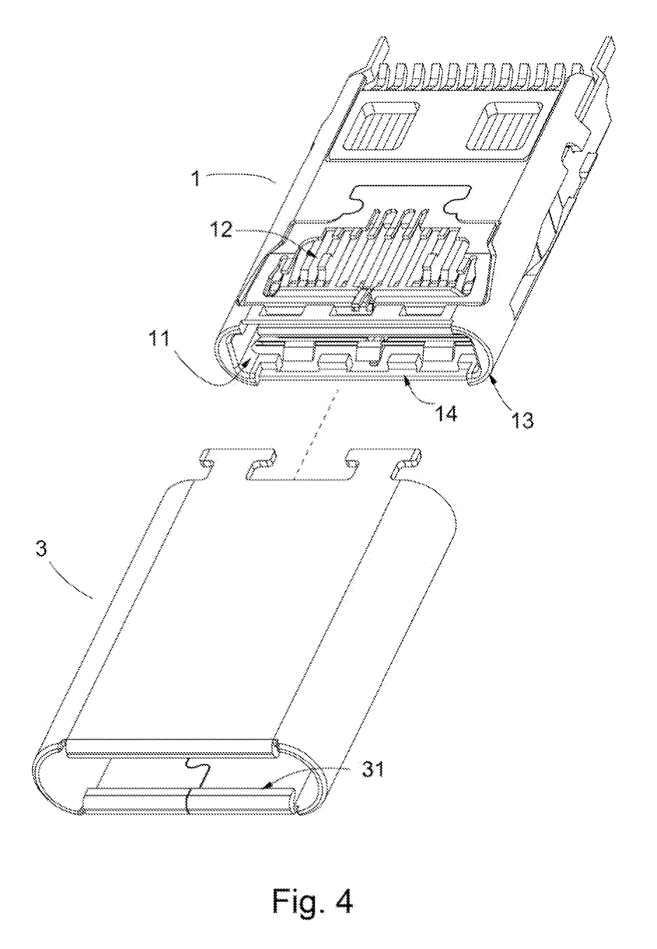

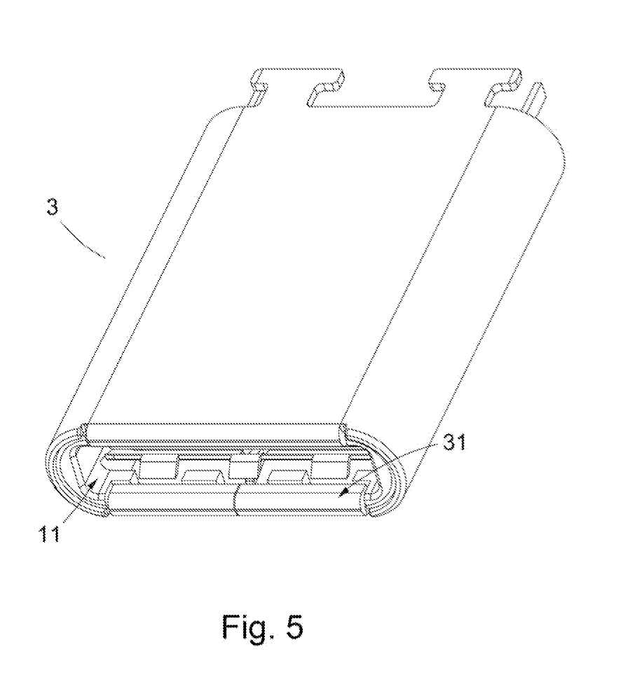

FIG. 4 shows a three-dimensional exploded view of a second preferred embodiment according to the present invention. The present embodiment is different from the first embodiment in that the recessions 14 on the insulating body are respectively and opposingly disposed on two sides of an inner wall in the insertion slot 11 instead of being arranged in a completely annular shape. The recessions 14 of the present embodiment are located in a position relatively closer to the rim opening 13 at a front of the terminal slot 12. The engagement parts 31 of the metal casing 3 are respectively formed via having a top and a bottom sides at one end of the metal casing 3 backbend inwards (as shown in FIG. 5) to correspondingly engage the recessions 14 on two sides of an inner wall in the insertion slot 11. Other assembling methods and utilization efficiency of the present embodiment are the same as those of the first embodiment and are therefore not repeated here.

As the foregoing description shows, in an electrical connector according to the present invention, a metal casing covering an insulating body extends in a direction of a rim opening at a circumference of the insertion slot and backbends inwards into the insertion slot. In this manner, the metal casing covers the rim opening of the insertion slot and strengthens the durability of the electrical connector. In addition, a circumference of the insertion slot may be closely connected with the metal casing, so that the plurality of conducting terminals on two sides in the insertion slot are kept stable to ensure stable signal transmission among the conducting terminals. In terms of its functions and assembling, an electrical connector according to the present invention is simpler and more convenient than a conventional one.

What is claimed is:

1. An electrical connector, for other male connectors to be correspondingly inserted thereinto, including at least:
an insulating body with an insertion slot formed in the shape of a mouth, on two side walls therein are arranged a plurality of conducting terminals;
a metal casing with a hollow annular structure to accommodate the insulating body, wherein a recession is arranged inside an inner side wall of the insertion slot extending from a rim opening at a front of the insertion slot into the insertion slot; wherein a surface height of the recession is lower than an inner side surface of the insertion slot; wherein a front edge at an annular end of the metal casing is arranged to backbend into a hollow annular shape to form an engagement part; and wherein the engagement part of the metal casing is arranged to extend from an outer side of the insulating body through a front end of the insulating body to be finally interlocked and positioned in the recession on an inner side of the insertion slot.

2. An electrical connector as defined in claim 1, wherein the plurality of conducting terminals conform to a specification of terminals of a standard USB Type-C female electrical connector.

3. An electrical connector as defined in claim 1, wherein the recession is arranged to indent in a completely annular shape along an inner side of the insertion slot and the engagement part is arranged in a completely annular shape to backbend inwards.

4. An electrical connector as defined in claim 1, wherein the recessions are respectively and opposingly disposed near a rim opening on two sides in the insertion slot and the engagement parts are respectively arranged to backbend inwards from two sides at one end of the metal casing.

5. An electrical connector as defined in claim 1, wherein the surface of the engagement part that backbends and is secured in the recession of the insertion slot is parallel to and of a same height as an inner side surface of the insertion slot.
